(19) United States
(12) Patent Application Publication
(10) Pub. No.: US 2026/0322917 A1
(43) Pub. Date: Oct. 15, 2026

(54) Systems, Apparatuses, and Methods for Communicating Call Information

(71) Applicant: Comcast Cable Communications, LLC, Philadelphia, PA (US)

(72) Inventors: Eric Wong, Edison, NJ (US); Vengatarajulu Rajasekar, Mount Laurel, NJ (US)

(21) Appl. No.: 19/179,189

(22) Filed: Apr. 15, 2025

(51) Int. Cl. H04M 3/436; H04M 3/42

(52) U.S. Cl. CPC H04M 3/436; H04M 3/42034

(57) ABSTRACT

Systems, apparatuses, and methods are described providing information about blocked calls. An originating network may receive a notification indicating that a call initiated by a calling device via the originating network has been blocked by another network. The originating network may generate one or more messages explaining the blocked call based on the received notification and output the one or more messages to (and/or for access by) the calling device. The originating network may negotiate with the other network to re-initiate the call.

### BACKGROUND

A call initiated by a user device from one network may be blocked by another network. The user device may not be able to receive a notification indicating that the call is blocked. Accordingly, a user of the user device may not receive the reason and/or remedies for the call block. Thus, the user may not be able to seek appropriate redress for the call block.

### SUMMARY

The following summary presents a simplified summary of certain features. The summary is not an extensive overview and is not intended to identify key or critical elements.

Systems, apparatuses, and methods are described for providing calling devices and/or calling device users with information about unsuccessful calls and/or for resolving causes of call blockage. A calling device associated with an originating network may initiate a call, via the originating network, to a called device associated with a receiving network. The receiving network may block the call based on analytics processing of the call and may send, to the originating network, a notification that comprises information (e.g., codes) that indicates one or more reasons for blocking the call and/or one or more ways to resolve what may have caused the call to be blocked. One or more servers or other computing devices in the originating network may receive the notification and may determine, based on the information in the notification, reason(s) and/or potential resolution(s) for the call block. The originating network may generate one or more messages (e.g., one or more text messages, voice messages, and/or other types of messages) that explain, in a form more understandable to a user, one or more reasons for the call block. The type of message(s) generated may be based on preferences associated with a user and/or with a calling device. The originating network may send the one or more generated messages to, and/or make the one or more generated messages otherwise available to (e.g., by storing in a call log), the calling device and/or the calling device user. The originating network may also initiate a negotiation with the receiving network about the call block and resolution of the call block. The originating network may, based on the negotiation, modify and re-initiate the call.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example of an originating network, a transit network, and a receiving network.

FIGS. 4A and 4B show communications and/or steps in one or more example methods associated with processing notifications associated with blocked calls.

FIG. 5 is a flow chart showing one or more example methods associated with processing notifications associated with blocked calls.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

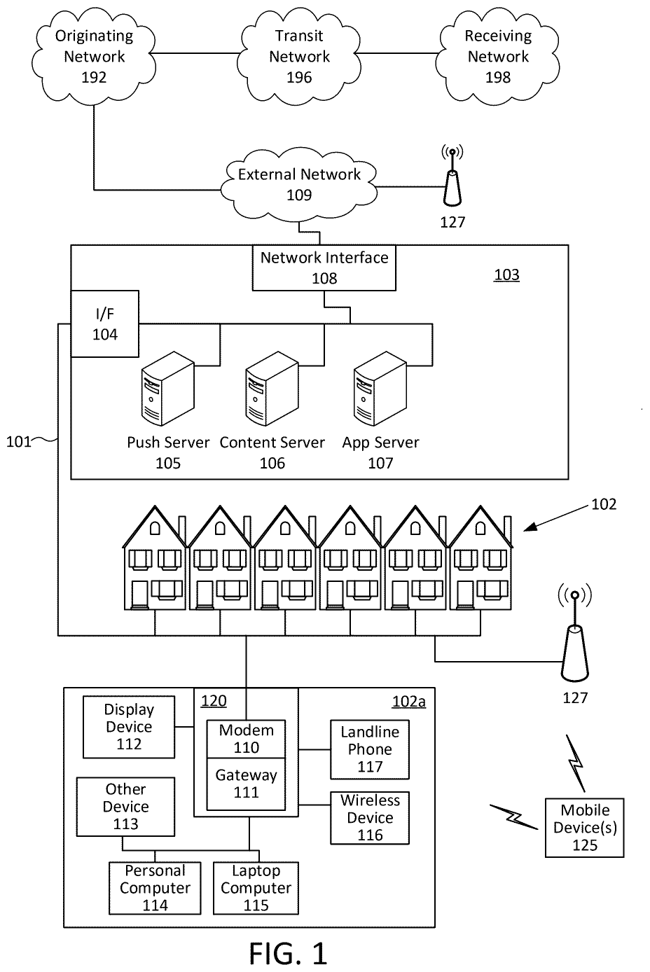

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, additional push, content, and/or application servers, and/or other types of servers. Although shown separately, the push server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein. Also or alternatively, one or more of servers 105, 106, 107, and/or other servers, may be part of and/or accessible via the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

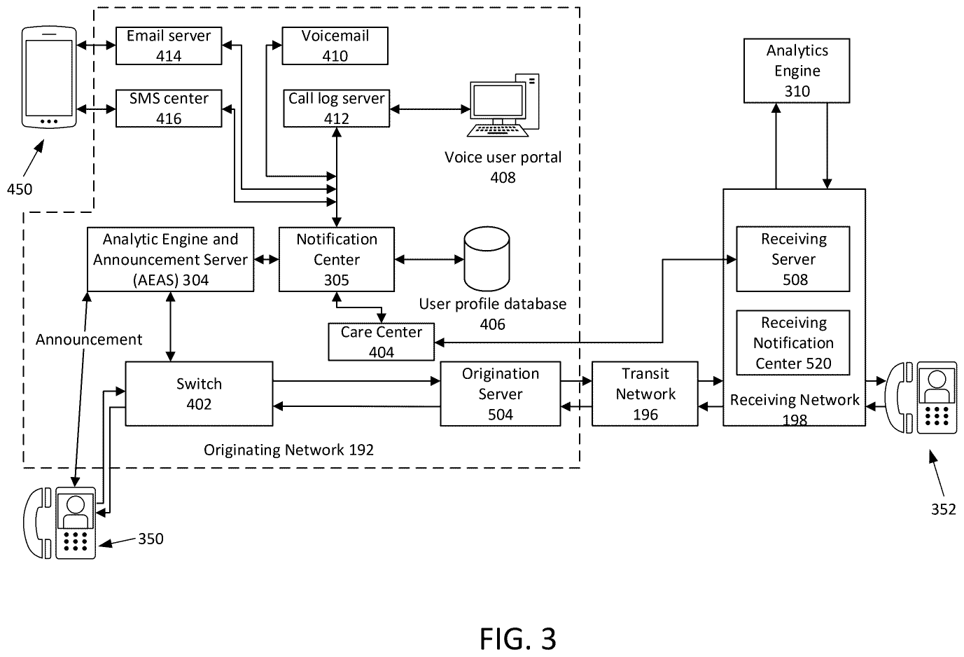

Devices in premises 102a (and/or other premises 102) may communicate, via the local office 103 and external network 109, via (and/or with elements in) originating network 192, transit network 196, and receiving network 198. Or alternatively, one or more of the originating network 192, the transit network 196, and the receiving network 198 may be different subnetworks (or other portions) of the network 109. The originating network 192, the transit network 196, and the receiving network 198 will be described in more detail in connection with FIG. 3 and subsequent figures.

The gateway 111 may also comprise one or more local network interfaces to communicate, via one or more local networks (e.g., networks local to the premises 102a), with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

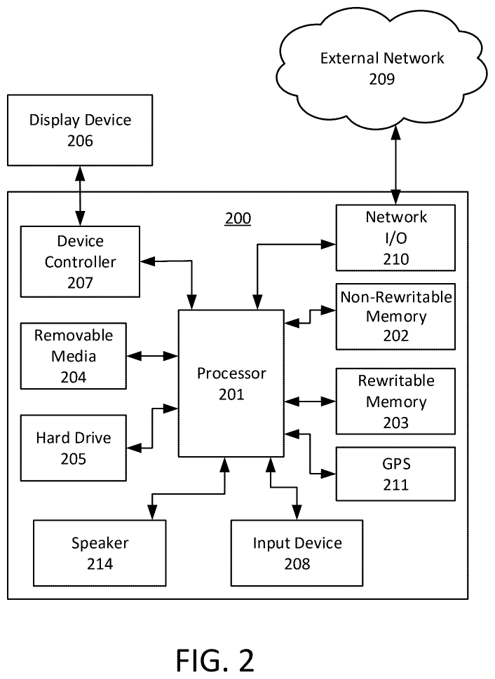

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices associated with any of the external network 109, the originating network 192, the transit network 196, and/or the receiving network 198) and any other computing devices discussed herein (e.g., the originating service provider 504, the receiving service provider 508, the analytic engine and announcement server (AEAS) 304, the notification center 305, the care center 404, and the analytics engine 310). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIG. 3 shows additional details of the originating network 192 and of the receiving network 198. A calling device 350 (e.g., a user device such as the landline phone 117 shown in FIG. 1) that may be configured as an endpoint (e.g., to function as a calling or a called device) for calls via the originating network 192. Another calling device 352 (e.g., another user device in another premises) may be configured as an endpoint (e.g., to function as a calling or a called device) for calls via the receiving network 198. The calling device 350 may initiate, via the originating network 192, a call to the called device 352. The originating network 192 may send, via one or more transit networks (e.g., the transit network 196), one or more call set-up messages to the receiving network 198 to establish that call (e.g., to create a session for two-way communication between the calling device 350 and the called device 352).

The receiving network 198 may process the call set-up message(s) by using its analytics engine 310 before completing the call (e.g., before transmitting information regarding the call to the called device 352). For example, the analytics engine 310 may determine whether the call may be unwanted contact from telemarketers, spam callers, harassers, or anyone else that a user may not want to reach them. The analytics engine 310 may also determine whether the call may be suspicious, fraudulent, or for other reasons undesirable. The analytics engine 310 may block the call if it determines that the call may be unwanted contact or otherwise suspicious based on its analytics, and further, feedback the block decision to the receiving network 198.

The analytics engine 310 may use different mechanisms defined by different standards for processing the call. For example, the analytics engine 310 may use a mechanism defined by the STIR/SHAKEN industry standard (e.g., protocols and procedures described by Secure Telephone Identity Revisited RFC standards of the Internet Engineering Task Force and Signature-based Handling of Asserted information using toKENs guidelines of public switched telephone networks). The receiving network 198 may, based on a determination by the analytics engine 310, as well as the call verification process based on the STIR/SHAKEN industry standard to block a call, generate one or more session initiation protocol (SIP) 603+ responses for a call block notification associated with the blocked call. The receiving network 198 may send that call block notification, via the transit network 196, to the originating network 192. A SIP 603+ response may provide information that comprises a unique reason phrase, such as “Network Blocked,” and a SIP reason header encoded per the Alliance for Telecommunications Industry Solutions (ATIS) documents “ATIS-1000099 Robocall Call Blocking Notification, Aug. 16, 2022.” A SIP 603+ response may also provide other types of information.

Generally, the call block notifications are maintained on network signaling levels as network messages, for example, by the receiving network 198, the transit network 196, and/or the originating network 192. Further, some user devices, such as the calling device 350, which may be a landline phone or a desk phone, may not be able to receive (or if able to receive, may not be able to process) the call block notifications even if they are made available. Some computing devices that may be used for calls (e.g., the wireless device 116 and/or the mobile device 125 shown in FIG. 1, other smart phones, tablets, laptop or desk computers) may be able to receive call block notifications in the form sent by a blocking network (e.g., a call block notification from the receiving network 198). Also shown in FIG. 3 is a user device 450, which may be such a computing device, and which may be associated with the calling device 350 (e.g., the user device 450 and the calling device 350 may be associated with the same user and/or a same account). But even if such a computing device is able to receive and output call block notifications, a user may not be able to understand information provided by the call block notifications. As such, users may be unable to determine the reasons why calls are blocked. If unable to determine why a call has been blocked, a user may be unable to resolve an issue that caused the call to be blocked. Accordingly, and as described below, one or more computing devices of the originating network 192 are configured to generate, based on a call block notification and in a form more likely to be understood by a user, one or more messages (e.g., one or more text messages, voice messages, and/or other types of messages) that explain one or more reasons for the call block.

The originating network 192 may comprise an analytic engine and announcement server (AEAS) 304 and/or a notification center 305 (e.g., one or more computing devices performing the herein-disclosed operations of the notification center 305), which may process a call block notification received from another network, and accordingly, generate and output, to the calling device 350, one or more messages explaining a reason and/or remedy for the blocked call. The AEAS 304 and/or the notification center 305 may output the one or more messages to the calling device 350 and/or to other user devices (e.g., user devices subscribed to one or more communication channels). For example, the AEAS 304 and/or the notification center 305 may generate and output the one or more messages based on a SIP 603+ reason header of a call block notification received from the receiving network 198. For example, the AEAS 304 may generate and output one or more voice messages that may comprise an announcement to a traditional phone of a user or a voicemail to a smart device associated with the user. The notification center 305 may generate one or more text messages that may comprise an email, a short message service (SMS), or a call log. The notification 305 may output the email and the SMS to the smart device associated with the user (e.g., the user device 450). The notification 305 may store the call log (e.g., as part of a call log history record) in a database accessible by a web portal (e.g., the voice user portal (VUP) 408 shown in FIG. 3). The user may retrieve the call log from the database through the web portal. As such, the user may seek redress for the blocked call in real-time. For example, and instead of a user needing to send requests for information about the call block from an operator of the originating network 192 and/or an operator of the receiving 198, the user may be able (in real-time or near real-time) to determine reasons for, and resolve, call blockage.

Although in the described examples, the calling device 350 and/or the called device 352 are landline/office phones, the methods may also or alternatively be performed in connection with calls where the calling device and/or the called device is a user device such as 450 shown in FIG. 3. In such cases, the announcement and/or one or more messages may be sent to the user device 450 just as it might be sent to the calling device 350.

As shown in FIG. 3, the receiving server 508 of the receiving network 198 (e.g., a server that may comprise one or more computing devices configured to receive calls directed to the called device 352 registered with the receiving network 198) may generate and send a call block notification through a receiving notification center 520. A call block notification may indicate that a call initiated by the calling device 350 via the originating network 192 is blocked. The originating network 192 may receive and process the call block notification and output the reason and remedies for the call block to the calling device 350 through one, some, or all available communication channels preferred by a user associated with the calling device 350 and/or the user device 450.

The receiving server 508 of the receiving network 198 may receive the call initiated by the calling device 350 via the originating network 192, and further, process the call by using the analytics engine 310 to determine whether the call should be blocked. The receiving server 508 may provide information regarding the call to the receiving notification center 520 if the analytics engine 310 determines the call should be blocked. The receiving server 508 may further process the call by using the analytics engine 310 to determine whether the call should be labeled as spam and blocked on that basis (e.g., if the analytics engine 310 determines the call should be not blocked for other reasons). The receiving server 508 may provide information of the call to the receiving notification center 520 if the analytics engine 310 determines the call should be labeled as spam. The analytics engine 310 may also analyze other types of features of the call.

The receiving notification center 520 may generate a call response (e.g., a call block notification) and send the call block notification to an origination server 504 (e.g., a server that may comprise one or more computing devices configured to set up calls initiated by the calling device 350 via the originating network 192) after the analytics engine 310 completes processing the call. The call block notification may comprise one or more encoded reasons and/or remedies for the call block, as shown in second column of Table 1 (described below). The call block notification may also comprise other types of information.

The originating network 192 may process a call block notification that is sent from the receiving network 198 (e.g., from the receiving notification center 520 of the receiving network 198) and transmitted through the transit network 196. The call block notification may comprise information such as an indication that a call initiated by the calling device 350 via the originating network 192 to the called device 352 is rejected based on analytics conducted by the analytics engine 310 of the receiving network 198 and/or the call is labeled as spam based on analytics conducted by the analytics engine 310 of the receiving network 198. The call block notification may comprise other types of information. The originating network 192 may generate and output one or more messages explaining a call block to the calling device 350.

For example, the originating service provider 504 may forward the call block notification to a switch device 402, which may be a computing device that directs the call block notification to the intended recipient devices, such as the calling device 350 and/or the AEAS 304, after it receives the call block notification sent by the receiving notification center 520. The AEAS 304 may determine whether the call block notification comprises a valid reason header, such as a SIP 603+ reason header. SIP 603+ reason header examples are shown below in Table 1:

TABLE 1

| Examples | Reason Headers | Meanings |
|---|---|---|
| 1 | Reason: SIP; cause = 603; | This call was blocked at |
| | text = “v = analytics1; | the originating network. |
| | url = https://example.com”; | The caller can visit |
| | location = LN | website example.com for |
| | | redress. |
| 2 | Reason: Q.850; cause = 21; | This call was blocked at |
| | text = “v = analytics1; tel =+ | the network serving the |
| | 12155551212”; location = RLN | called party. The caller can |
| | | call (215) 555-1212 for |
| | | redress. |
| 3 | Reason: SIP; cause = 603; | This call was blocked at |
| | text = “v = analytics1; | the originating network. |
| | url = https://example.com; | The caller can either visit |
| | email = support@example.com; | the example.com webpage, |
| | tel =+ 12155551212; id = | send an email |
| | 29016905-3bed4c98-9423- | to support@example.com, |
| | 03041160cc67”; location = LN | or call (215) 555-1212 for |
| | | redress. A call ID number |
| | | was provided to facilitate |
| | | redress. |

The AEAS 304 may determine a preference associated with the calling device 350 if the call block notification comprises a valid reason header. For example, the AEAS 304 may look at information associated with the calling device 350, and/or instruct the notification center 305 to perform a lookup in the user profile database 406. A preference associated with the calling device 350 may, for example, be set by a user of the calling device 350 with the originating network 192 in advance. A preference associated with the calling device 350 may be dynamically changed by the calling device 350 with the originating network 192. The AEAS 304 may generate one or more messages, which may explain the reason and remedies for the call block, in a form of announcement (e.g., voice messages) if a preference associated with the calling device 350 is for announcement. For example, the AEAS 304 may map information (e.g., encoded information) provided by the call block notification to a text message. The AEAS 304 may further convert the text message to audio by applying a text-to-speech conversion and generate a voice message. Also or alternatively, the AEAS 304 may map the encoded information provided by the call block notification to a pre-existing voice message.

The announcement may comprise information indicating that “This call was blocked at the originating network. The caller can visit website example.com for redress,” which corresponds to the reason header of the first call block notification example in Table 1. The AEAS 304 may apply a text-to-speech conversion to generate the announcement. The AEAS 304 may, for example, extract text from a reason header such as the example reason headers of Table 1 and convert the extracted text to a voice message (e.g., using a text to voice synthesizer). The AEAS 304 may output the announcement to the calling device 350 so the user of the calling device 350 may understand that the call is blocked, and further, the reason behind the blocked call and possible redress for the blocked call. Optionally, the AEAS 304 may take no action (e.g., no messages may be generated and outputted to the calling device 350) if the call block notification does not comprise a valid reason header, as the AEAS may thus be unable to extract information regarding potential reason and/or remedies for the call block.

The AEAS 304 may transmit the call block notification to the notification center 305 if the call block notification comprises a valid reason header. The notification center 305 may go through a user profile database 406 of the originating network 192 to determine whether the calling device 350 is associated with a user profile stored in the user profile database 406. The user profile database 406 may be installed in the originating network 192, or located in a remote server or a cloud infrastructure associated with the originating network 192.

The notification center 305 may determine a preference for voicemail, call log, email, and/or SMS based on a user profile associated with the calling device 350 if the user profile can be retrieved from the user profile database 406. Accordingly, the notification center 305 may generate one or more messages explaining the reason and remedies for the call block, and further, use available communication channels (e.g., voicemail, call log, email, and/or SMS) to output the one or more messages to the calling device 350. In addition, the notification center 305 may apply a speech-to-text conversion and convert the announcement generated by AEAS 304 to one or more text messages and output the one or more text messages to the user device 350 (if the calling device 350 is able to receive text message), the user device 450, and/or one or more other computing devices.

For example, the notification center 305 may instruct a computing device 410 that processes (e.g., generates) and outputs voicemails to output a voicemail to the calling device 350 through a communication channel for announcement provided by the AEAS 304 if the user profile associated with the calling device 350 indicates a preference for voicemail. The notification center 305 may instruct a call log server 412 to write and store a call log (e.g., as part of a call log history record) in a database for access by a web portal (e.g., the VUP 408 shown in FIG. 3) if the user profile associated with the calling device 350 indicates a preference for call log. The VUP 408 may fetch and display the call log based on a request from a user of the calling device 350. The notification center 305 may instruct an email server 414 to output an email to the user device 450 that is associated with the calling device 350 if the user profile associated with the calling device 350 indicates a preference for email. The notification center 305 may instruct an SMS center 416 to output an SMS to the user device 450 if the user profile associated with the calling device 350 indicates a preference for SMS.

The notification center 305 may transmit the call block notification to a care center 404 (e.g., a computing device configured to perform operations described herein as performed by the care center 404). The care center 404 may, as described in more detail below, communicate with the receiving network 198 to negotiate the reason and remedies indicated in a call block notification so that a blocked call may be reinitiated and successfully established with the called device 352. The care center 404 may also provide other types of services (e.g., customer support, account management, technical support, etc.).

The care center 404 may initiate a negotiation with the receiving server 508 regarding a call block notification sent by the receiving notification center 520. For example, the care center 404 may send one or more first messages requesting the receiving server 508 to provide more information for the reason that the call is rejected. In response, the receiving server 508 may send one or more first replying messages explaining in detail why the call is rejected. The care center 404 may send one or more second messages providing evidence to prove that the call initiated by the calling device 350 from the originating network 192 is legitimate and thus should not be blocked. This sequence may be repeated, for example, if the receiving server 508 requires more information/evidence. A message from the care center 404 and/or from the receiving server 508 may indicate one or more options for modifying a call to resolve a cause of the blocking. The care center 404 may send one or more messages providing other types of information to the receiving server 508 in order to re-initiate the call that is blocked.

The negotiation between the care center 404 and the receiving server 508 may be successful if the receiving server 508 sends one or more messages indicating that the call is acceptable and/or that a call modified according to options suggested by the care center 404 or by the receiving server 508 is acceptable. The care center 404 may re-initiate the call. Additionally and/or alternatively, the care center 404 may modify the call according to these possible options and re-initiate the modified call. The care center 404 may send one or more messages requesting the receiving server 508 to remove the calling device 350 (e.g., an identity of the user device 350) from the blacklist used for its analytics-based call processing, and/or to remove a spam label that was added to the identity of the calling device 350 during its analytics-based call processing. The care center 404 may send one or more messages requesting the receiving server 508 to take other actions so that future calls initiated by the calling device 350 from the originating network 192 will not be blocked.

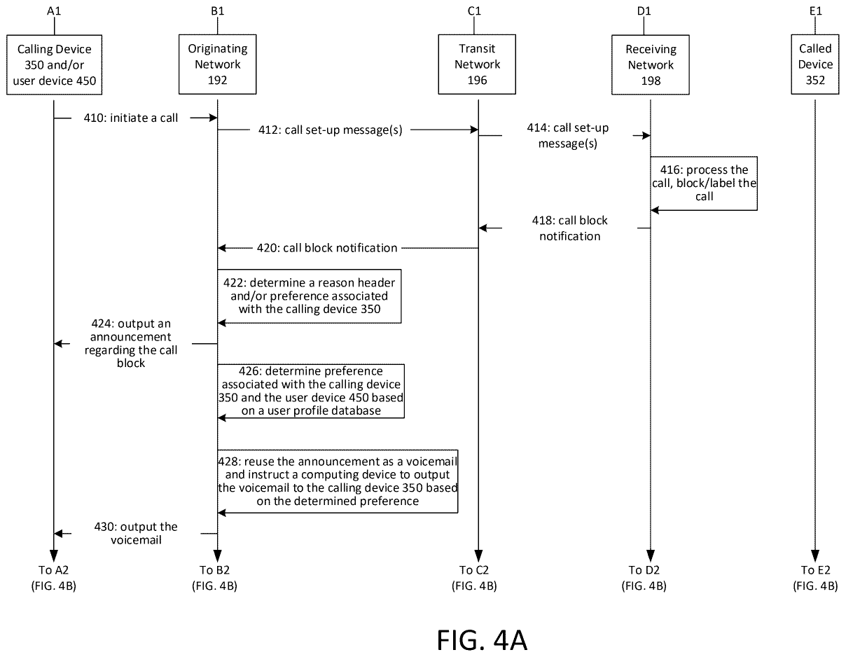

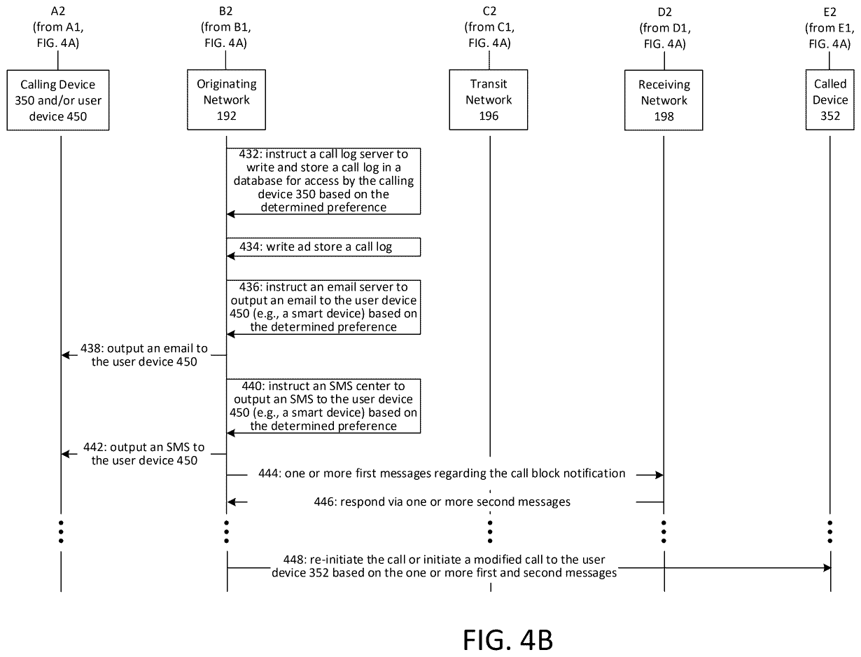

FIGS. 4A and 4B are a diagram showing communications and/or steps in one or more example methods associated processing notifications associated with a blocked call. FIG. 4B is a continuation of FIG. 4A, as indicated at the bottom of FIG. 4A and at the top of FIG. 4B. Although FIGS. 4A and 4B show certain computing devices from FIGS. 1 and 3 as examples of computing devices that may perform one of more of the steps described below, one, some, or all of those steps may be performed by one or more other computing devices. The devices shown in FIGS. 4A and 4B (and/or other computing devices) may be configured (e.g., based on stored instructions) to perform steps such as are described herein. One or more of the communications and/or steps shown in FIGS. 4A and 4B may be rearranged, omitted, and/or otherwise modified, and/or other steps and/or communications added. A communication shown in, and/or described in connection with, FIGS. 4A and 4B need not be a single message nor contained in a single packet, block, or other transmission unit.

Vertical lines A1 (FIG. 4A) and A2 (FIG. 4B) correspond to the calling device 350 and/or the user device 450. Vertical lines B1 (FIG. 4A) and B2 (FIG. 4B) correspond to the originating network 192. Vertical lines C1 (FIG. 4A) and C2 (FIG. 4B) correspond to the transit network 196. Vertical lines D1 (FIG. 4A) and D2 (FIG. 4B) correspond to the receiving network 198. Vertical lines E1 (FIG. 4A) and E2 (FIG. 4B) correspond to the called device 352.

In step 410, the calling device 350 may initiate a call to the other called device 352 via the originating network 192. In step 412, the originating network 192 may send one or more call set-up messages to establish the call. In step 414, the transit network 196 may send/forward the one or more call set-up messages to the receiving network 198. In step 416, the receiving network 198 may process call (e.g., process the one or more call set-up messages) by, for example, using the analytics engine 310. In step 416 the receiving network 198 may determine the call should be blocked and/or labeled as a spam call, and may generate a call block notification based on the determination.

In step 418, the receiving network 198 may send the call block notification (generated in step 416) to the originating network 192. In step 420, the transit network 196 may send/forward the call block notification to the originating network 192. In step 422, the originating network 192 (e.g., the origination server 504 shown in FIG. 3) may process the call block notification. For example, the origination server 504 may forward the call block notification to a switch device 402 (shown in FIG. 3), which may further forward the call block notification to one or more servers and/or one or more computing devices of the originating network 192. As part of step 422, an AEAS 304 (the AEAS 304 of the originating network 192 shown in FIG. 3) may determine whether the call block notification comprises a valid reason header. As also part of step 422, the AEAS 304 may determine a preference associated with the calling device 350 (e.g., by looking at information associated with the calling device 350, and/or by instructing the notification center 305 to perform a lookup in the user profile database 406). The AEAS 304 may generate a voice message based on the call block notification (e.g., by mapping the codes contained in the call block notification to a text message and applying a text-to-speech conversion, or by mapping these codes to a pre-exist voice message) if a preference associated with the calling device 350 is for announcement. In step 424, the AEAS 304 may output an announcement comprising the voice message to the calling device 350.

In step 426, the originating network 192 may further process the call block notification. For example, the notification center 305 (e.g., in response to a query from the AEAS 304) may determine a preference associated with the calling device 350 for voicemail, call log, email, and/or SMS based on a user profile that is associated with the calling device 350 and stored in the user profile database 406. In step 428, the notification center 305 may instruct a computing device (the computing device 410 shown in FIG. 3) to output a voice message to (and/or store a voicemail accessible by) the calling device 350 if the notification center 305 determines that the preference associated with the calling device 350 is for voicemail. The notification center 305 may re-use the voice message generated by the AEAS in step 422. In step 430, the computing device 410 may output the voice message to (and/or store the voicemail for access by) the calling device 350.

In step 432 (FIG. 4B), the notification center 305 may instruct the call log server 412 to write and store a call log (e.g., as part of a call log history record) in a database associated with a web portal (e.g., the VUP 408 shown in FIG. 3) if it determines that the preference associated with the calling device 350 is for call log. The web portal may fetch the call log from the database and display the call log based on a request from a user of the calling device 350. In step 434, the call log server 412 may write and store the call log for access by the calling device 350. In step 436, the notification center 305 may instruct the email server 414 to output an email to the user device 450 if the notification center 305 determines that a preference associated with the calling device 350 indicates a preference for email. In step 438, the email server 414 may output the email to the user device 450. In step 440, the notification center 305 may instruct the SMS center 416 to output an SMS text message to the user device 450 if the notification center 305 determines that the preference associated with the calling device 350 is for SMS. In step 442, the SMS center 416 may output the SMS text message to the user device 450.

In step 444, the originating network 192 may further process the call block notification. For example, the care center 404 may initiate a negotiation with the receiving network 198 by sending, to the receiving server 508 of the receiving network 198, one or more messages. In step 446, the receiving server 508 may respond and send to the care center 404 one or more messages indicating why the call is blocked and/or possible remedies of the condition(s) that cause the call to be blocked. The negotiation between the care center 404 of the originating network 192 and the receiving server 508 of the receiving network 198 may comprise repeatedly sending and/or receiving one or more messages if the care center 404 and/or the receiving server 508 requires more information/evidence. In step 448, the originating network 192 may re-initiate the call (or a modified version of the call) and may send one or more call-set-up messages for the call (or a modified version of the call) based on information in one or more of messages in step 444, in step 446, and/or other negotiation messages. The call (or the modified version of the call) may reach the called device 352.

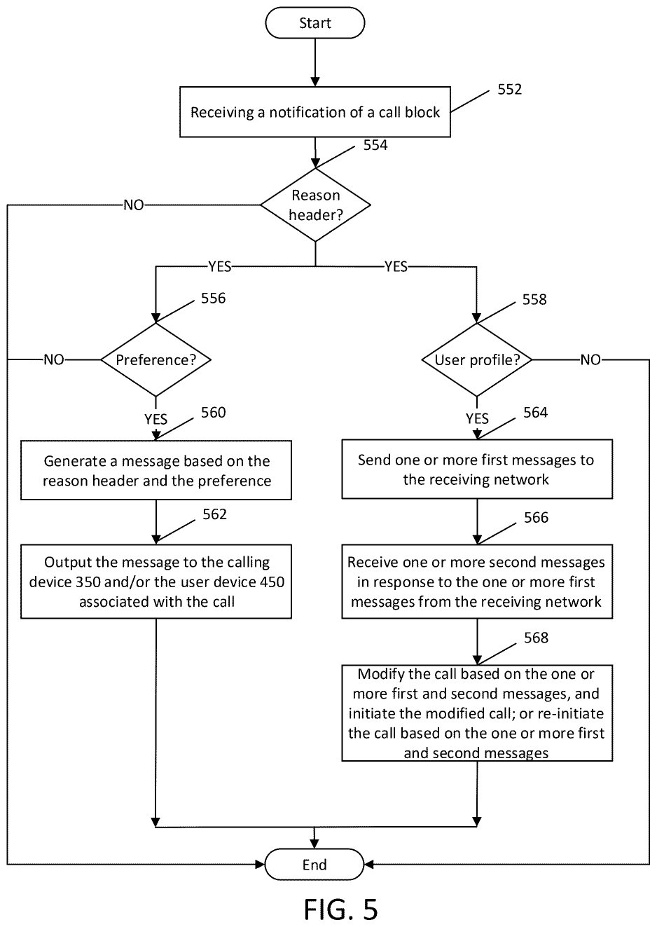

FIG. 5 is a flow chart showing one or more example methods associated with processing notifications associated with blocked calls. The processing may comprise generating and/or outputting one or more messages indicating a call block to a calling device initiating the call (e.g., the calling device 350) through one or more communication channels indicated by one or more preferences associated with the calling device. Although various steps described by example of performance by certain computing devices of the originating network 192, one, some or all steps could be performed by one or more other computing devices. One or more steps may be rearranged (e.g., performed in different order), omitted, or otherwise modified, and/or steps may be added.

In step 552, the origination server 504 of the originating network 192 may receive a call block notification indicating that a call, initiated by the calling device 350, has been blocked by the receiving network 198. Step 552 may, for example, comprise (or be comprised by) step 420 of FIG. 4A.

In step 554, which may be performed based on receiving the notification in step 552, an AEAS 304 may determine whether the call block notification contains a valid reason header. The AEAS 304 may make the determination of step 554 by checking a pre-defined structure of the call block notification, a specific field for headers of the call block notification, and/or a fixed-size field for headers of the call block notification. Step 554 may, for example, comprise (or be comprised by) step 422 of FIG. 4A. If the call block notification does not comprise a valid reason header (“no” branch), the method may end (e.g., the AEAS 304 may proceed no further and no messages may be generated or outputted to the calling device 350). If the call block notification does comprise a valid reason header (“yes” branch), steps 556 and 558 may be performed. Although FIG. 5 shows steps 556, 560 and 562 performed in one branch and steps 558, 564, 566, and 568 performed in a parallel branch, steps of these branches may alternately be performed serially in a single branch.

In step 556, the AEAS 304 may determine whether there is a preference, associated with the calling device 350, for receiving messages through announcement from the originating network 192. Step 556 may comprise, for example, the notification center 305 determining (e.g., in response to a query from the AEAS 304) whether the calling device 350 is associated with a user profile stored in the user profile database 406. The notification center 305 may further determine what the associated user profile indicates if there is an associated user profile stored in the user profile database 406. For example, the notification center 305 may determine whether there is a preference for receiving messages through other types of communication channels, such as call log, email, text message, and/or voicemail, from the originating network 192. Step 556 may, for example, comprise (or be comprised by) step 422 and/or 426 of FIG. 4A.

The AEAS 304 and/or the notification center 305 may proceed no further (e.g., no messages may be generated and outputted to the calling device 350) if there is no preference, associated with the calling device 350, for receiving messages from the originating network 192. The method may end, the calling device 350 may not receive information regarding the blocked call, and a user of the calling device 350 may not be able to seek redress for the blocked call.

In step 560, which may be performed based on a determination that there is a preference, associated with the calling device 350, for receiving messages through announcement, call log, email, text message, and/or voicemail from the originating network 192, the AEAS 304 and/or the notification center 305 may generate one or more messages in a form of announcement, call log, email, text message, and/or voicemail.

Step 560 may comprise, for example, the AEAS 304 extracting information (e.g., encoded information) comprised by a reason header of the call block notification and mapping the information to a text message that explains the reason why the call is blocked. The AEAS 304 may extract other information (e.g., encoded information) comprised by the reason header of the call block notification and map that information to the same text message or another text message. The other information may comprise possible remedies for the blocked call. The AEAS 304 may further convert the text message to audio by applying a text-to-speech conversion and generate a voice message (e.g., an announcement). Additionally and/or alternatively, the AEAS 304 may extract information (e.g., encoded information) comprised by the reason header of the call block notification and map the information to pre-existing a voice message (e.g., an announcement) that explains the reason why the call is blocked.

Step 560 may comprise, for example, the notification center 305 similarly extracting information (e.g., encoded information) comprised by the reason header of the call block notification and mapping the information to a text message and/or a voice message that explains the reason why the call is blocked. Additionally and/or alternatively, the notification center 305 may convert the announcement generated by the AEAS 304 to a text message by applying a speech-to-text conversion and generate an email, a call log, an SMS text message. Additionally and/or alternatively, the notification center 305 may re-use the announcement generated by the AEAS 304 and generate a voicemail. Step 560 may, for example, comprise (or be comprised by) step 428 of FIG. 4A.

In step 562, which may be performed based on generating the one or more messages (e.g., the announcement, email, call log, SMS, and/or voicemail) for the calling device 350, the AEAS 304 may output the announcement to the calling device 350 (e.g., play the announcement to the calling device 350 and/or save the announcement as a voice mail accessible by the calling device 350).

Step 562 may comprise the notification center 305 instructing the computing device 410 to output the announcement to (or save the announcement as a voicemail accessible by) the calling device 350. The notification center 305 may instruct the call log server 412 to write and store a call log (e.g., as part of a call log history record) in a database for access by the calling device 350 through a web portal (e.g., the VUP 408 shown in FIG. 3). The notification center 305 may instruct the email server 414 to output an email to the user device 450 associated with the calling device 350. The notification center 305 may the SMS center 416 to output an SMS text message to the user device 450. Step 562 may, for example, comprise (or be comprised by) step 424 and/or step 430 of FIG. 4A and/or step 432, step 434, step 436, step 438, step 440, and/or step 442 of FIG. 4B.

In step 558, the notification center 305 may determine whether the calling device 350 is associated with a user profile stored in the user profile database 406. Step 558 may comprise, for example, the notification center 305 determining which remedies, for blocked calls, that are feasible for the calling device 350 based on the associated user profile. Step 558 may comprise, for example, the notification center 305 determining a type of the calling device 350 and/or an identify of a user of the calling device 350 based on the associated user profile. Step 558 may comprise, for example, the notification center 350 sending the information determined based on the associated user profile to the care center 404. The notification center 305 may proceed no further (e.g., no information may be sent to the care center 404) if there is no user profile associated with the calling device 350.

In step 564, which may be performed based on a determination that there is a user profile associated with the calling device 350, the care center 404 may send one or more first messages to the receiving network 198. The one or more first messages may comprise a request for the receiving server 508 to explain the reason for the call block in more detail, evidence to authenticate the call so the calling device 350 may resume the call, indications of possible options for modifying the call (e.g., based on what may be determined feasible in step 558), and/or a demand that the receiving server 508 remove the calling device 350 from a list of phones/phone numbers that may be automatically blocked by the receiving network 198. The one or more first messages may comprise other types of information. Step 564 may, for example, comprise (or be comprised by) step 444 of FIG. 4B.

In step 566, which may be performed based on the care center 404 sending the one or more first messages to the receiving network 198 in step 564, the care center 404 may receive one or more second messages from the receiving network 198. The one or more second messages may comprise information from the receiving server 508 explaining the reason and/or remedies for the call block in more detail, a request for more evidence to authenticate the call so the call may be completed, and/or indications of possible options for modifying the call in a way that is acceptable for the receiving network 198. The one or more second messages may comprise other types of information. After step 566, step 564 may repeat. Step 566 may, for example, comprise (or be comprised by) step 446 of FIG. 4B.

In step 568, which may be performed based on the communications between the care center 404 and the receiving server 508 in steps 564 and 566, the origination server 504 may modify the call based on the one or more first messages and the one or more second messages, and initiate the modified the call to the receiving network 198. Step 568 may also comprise, for example, the origination server 504 re-initiating the call based on the one or more first messages and the one or more second messages. Step 568 may, for example, comprise (or be comprised by) step 448 of FIG. 4B.

The information that the networks (e.g., the care center 404 of the originating network 192 and the receiving server 508 of the receiving network 198) are attempting to automatically resolve the issue causing the block may be indicated in the announcement and/or the one or more messages (e.g., generated and output in steps 422-430 of FIG. 4A, steps 432-442 of FIG. 4B, and/or steps 556-562 of FIG. 5) to the user of the calling device 350 and/or the user device 450. The announcement and/or the one or more messages may further indicate that the user may wait for the call to go through or for a further announcement and/or message indicating the issue could not be resolved (e.g., the attempted resolution between the networks is unsuccessful).

Also or alternatively, the methods associated with FIGS. 4A, 4B, and 5 may be modified so that the attempted resolution between the networks (e.g., steps 444-448 of FIG. 4B and/or 558-568 of FIG. 5) may be performed first, and if unsuccessful, the other steps of generating and outputting announcement and/or messages (e.g., steps 422-430 of FIG. 4A, steps 432-442 of FIG. 4B, and/or steps 556-562 of FIG. 5) may be performed. For example, with reference to FIGS. 4A and 4B, steps 444-448 of FIG. 4B may be performed after step 422 (e.g., modified step 422) of FIG. 4A. In modified step 422 of FIG. 4A, the AEAS 304 may determine whether the call block notification comprises a valid reason header. As part of modified step 422 of FIG. 4A, the notification center 305 (e.g., in response to a query from the AEAS 304) may determine whether there is a user profile that is associated with the calling device 350 and stored in the user profile database 406. Steps 444-448 of FIG. 4B may be performed based on a valid reason header and a user profile associated with the calling device 350. If the attempted resolution between the networks is successful, steps 424-430 of FIG. 4A and steps 432-442 of FIG. 4B may not be performed. If the attempted resolution between the networks is unsuccessful, steps 422-430 of FIG. 4A and steps 432-442 of FIG. 4B may be performed. The announcement and one or more messages may comprise information indicating that the attempted resolution of the issue causing the block is unsuccessful, in addition to the reason for blocking and potential remedy. Steps 422 and 428 of FIG. 4A and steps 432, 436, and 440 may be modified steps, in which the AEAS 304 and/or the notification center 305 may generate announcement and/or messages that additionally comprise the information indicating the attempted resolution.

For example, with reference to FIG. 5, steps 558-568 may be performed before steps 556-562. If the attempted resolution between the networks is successful, steps 556-562 may not be performed. If the attempted resolution between the networks is unsuccessful, steps 556-562 may be performed. The announcement and one or more messages may comprise information indicating that the attempted resolution of the issue causing the block is unsuccessful, in addition to the reason for blocking and potential remedy. Step 560 may be a modified step, in which the AEAS 304 and/or the notification center 305 may generate announcement and/or messages that additionally comprise the information indicating the attempted resolution.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by one or more computing devices associated with an originating network via which a call was initiated by a calling device, one or more first messages indicating that the call was blocked by a receiving network;
determining, based on the received one or more first messages, a reason that the call was blocked;
generating, based on the determined reason, one or more second messages that comprise one or more of:
a text explanation of the reason that the call was blocked, or
a voice announcement explanation of the reason that the call was blocked; and
outputting the one or more second messages.

2. The method of claim 1, wherein the outputting comprises:
sending, to a user device associated with the calling device, the one or more second messages.

3. The method of claim 1, wherein the one or more second messages comprise the voice announcement, and wherein the outputting comprises:
sending, to the calling device and based on a preference associated with the calling device, the voice announcement.

4. The method of claim 1, wherein the one or more second messages comprise the text explanation, and wherein the outputting comprises:
sending, to a user device associated with the calling device and based on a preference associated with the calling device, the text explanation.

5. The method of claim 1, wherein the one or more second messages comprise the text explanation, and wherein the outputting comprises one or more of:
storing the text explanation as part of a call log history record,
sending an email comprising the text explanation, or
sending a text message comprising the text explanation.

6. The method of claim 1, wherein the determining comprises:
extracting, from a reason header of the one or more first messages, one or more indications of the reason that the call was blocked.

7. The method of claim 1, wherein the generating comprises:
mapping one or more codes, indicated by the received one or more first messages, to one or more of:
the text explanation of the reason, or
the voice announcement explanation of the reason.

8. The method of claim 1, wherein the generating comprises:
generating, using text-to-speech conversion of the text explanation, the voice announcement.

9. The method of claim 1, further comprising:
sending, to the receiving network, one or more third messages to resolve the reason that the call was blocked;
receiving, in response to the one or more third messages and from the receiving network, one or more fourth messages indicating that the call is acceptable; and
re-initiating, based on the one or more fourth messages, the call.

10. A method comprising:
receiving, by one or more computing devices associated with an originating network via which a call was initiated by a calling device, one or more messages indicating that the call was blocked by a receiving network;
based on one or more indications, in a reason header of the one or more messages, of a reason that the call was blocked:
determining, based on the reason header, a text explanation of the reason that the call was blocked; and
generating, based on a preference associated with the calling device and based on the text explanation, a voice announcement explanation of the reason that the call was blocked; and
causing output of the voice announcement.

11. The method of claim 10, wherein the causing output comprises one or more of:
sending, to the calling device, the voice announcement, or
storing, as a voice mail accessible by the calling device, the voice announcement.

12. The method of claim 10, wherein the generating comprises:
generating, using text-to-speech conversion of the text explanation, the voice announcement.

13. The method of claim 10, wherein the determining comprises one or more of:
extracting the text explanation from the reason header; or
mapping one or more codes, extracted from the reason header, to the text explanation.

14. The method of claim 10, wherein the causing output comprises one or more of:
storing the text explanation as part of a call log history record,
sending an email comprising the text explanation, or
sending a text message comprising the text explanation.

15. A method comprising:
extracting, by one or more computing devices associated with an originating network via which a call was initiated by a calling device, and from a reason header of one or more first messages from a receiving network associated with a called device, one or more codes indicating a reason that the call was blocked;
generating, based on the extracted one or more codes, one or more second messages that comprise one or more of:
a text explanation of the reason that the call was blocked, or
a voice announcement explanation of the reason that the call was blocked; and
causing output of the one or more second messages.

16. The method of claim 15, wherein the one or more second messages comprise the text explanation, and wherein the causing output comprises one or more of:
storing the text explanation as part of a call log history record,
sending an email comprising the text explanation, or
sending a text message comprising the text explanation.

17. The method of claim 15, wherein the generating comprises:
mapping the extracted one or more codes to one or more of:
the text explanation of the reason, or
the voice announcement explanation of the reason.

18. The method of claim 15, wherein the generating comprising:
generating, using text-to-speech conversion of the text explanation, the voice announcement.

19. The method of claim 15, wherein the one or more second messages comprise the voice announcement, and wherein the causing output comprises:
sending, to the calling device and based on a preference associated with the calling device, the voice announcement.

20. The method of claim 15, wherein the one or more second messages comprise the text explanation, and wherein the causing output comprises:
sending, to a user device associated with the calling device and based on a preference associated with the calling device, the text explanation.
